(19) United States
(12) Patent Application Publication
(10) Pub. No.: US 2013/0306412 A1
(43) Pub. Date: Nov. 21, 2013

(54) SAFETY RELEASE

(71) Applicant: SUSPA GMBH, Altdorf (DE)

(72) Inventors: Glen Robert Wilkinson, Paw Paw, MI (US); Kevin Thomas Braat, Portage, MI (US)

(73) Assignee: Suspa GmbH, Altdorf (DE)

(21) Appl. No.: 13/774,431

(22) Filed: Feb. 22, 2013

Related U.S. Application Data
(60) Provisional application No. 61/647,571, filed on May 16, 2012.
(60) Provisional application No. 61/672,925, filed on Jul. 18, 2012.
(60) Provisional application No. 61/647,566, filed on May 16, 2012.
(60) Provisional application No. 61/672,920, filed on Jul. 18, 2012.
(60) Provisional application No. 61/758,997, filed on Jan. 31, 2013.

(51) Int. Cl. F16B 7/14

(52) U.S. Cl. CPC F16B 7/1418
USPC 188/67

(57) ABSTRACT

A safety release for a clamping brake mechanism in which the clamping force increases with increasing loads and the force required to release the clamping brake also increases. The safety release comprises a fixed housing, a cable release coupled to the housing, a pivot link coupling an end of said cable release and constrained to pivot through a predetermined arc. A release rod is coupled to an end of the pivot link remote from the release lever, and a compression spring extends between the end of said pivot link and the release rod, such that the spring will compress in the event the force to move the release rod exceeds the spring constant. This compresses the spring and prevents the release rod from moving to release the clamping brake. The compression spring, in one embodiment, comprises a plurality of stacked Belleville washers.

### CROSS-REFERENCE TO RELATED APPLICATIONS

This application claims priority under 35 U.S.C. § 119(e) and the benefit of U.S. Provisional Application Nos. 61/647,571 entitled SAFETY RELEASE filed May 16, 2012, by Wilkinson et al.; 61/672,925 entitled SAFETY RELEASE filed Jul. 18, 2012, by Wilkinson et al.; 61/647,566 entitled DOUBLE ACTING FLUID CYLINDER LOCK filed May 16, 2012, by Wilkinson et al.; 61/672,920 entitled DOUBLE ACTING FLUID CYLINDER LOCK filed on Jul. 18, 2012, by Wilkinson et al.; and 61/758,997 entitled SELF-ALIGNING AXIAL BEARING, filed on Jan. 31, 2013, by Wilkinson et al., the entire disclosures of which are incorporated herein by reference.

### BACKGROUND OF THE INVENTION

The present invention relates to a release mechanism for a mechanical brake which will prevent release of the brake in the event of an overload.

Fluid cylinders used for raising and lowering adjustable tables, such as gas springs, are controlled by a variety of means to allow height adjustment without excessive sudden movement. Several designs exist for the control of gas springs typically used in table and chair height adjustments. Use of such gas springs is commonplace in the furniture industry in which chairs, tables, and other items are desired to be easily adjustable. Typically, the gas spring force is selected to counterbalance a normal weight load expected on a chair or table, and the stroke of the gas spring is selected for the desired amount of movement. To control telescopic support tubes in which gas springs are employed, mechanical locking mechanisms have been employed as well as controlling the flow of fluid on either side of the piston of a gas spring. When a table or chair is overloaded or has no load, the release of the position locking mechanism can result in the undesired sudden movement of the table or chair. This invention provides a safety release preventing such sudden movement.

### SUMMARY OF THE INVENTION

The present invention is a safety release for a clamping brake mechanism in which the clamping force increases with increasing loads and the force required to release the clamping brake also increases. The safety release comprises a fixed housing, an actuator coupled to the housing, and a release lever, which is constrained to move through a predetermined distance. A compression spring extends between the end of the release lever and the release rod, such that the spring will compress in the event the force to move the release rod exceeds the spring constant. This compresses the spring and the constrained movement of the release lever prevents the release rod from moving to release the clamping brake. The compression spring, in one embodiment, comprises a plurality of stacked Belleville washers.

These and other features, objects and advantages of the present invention will become apparent upon reading the following description thereof together with reference to the accompanying drawings.

### BRIEF DESCRIPTION OF THE DRAWINGS

FIG. 1 is a perspective view of two adjustable tables incorporating the system of the present invention;

FIG. 2 is a side elevational view of a telescopic leg of the table supports shown in FIG. 1;

FIG. 3 is a vertical cross-sectional view of an adjustable table support embodying the locking and release mechanism of the present invention;

FIG. 4 is an enlarged fragmentary cross-sectional view of the locking mechanism shown in FIG. 3;

FIG. 5 is a fragmentary cross-sectional view of the locking mechanism seen in FIG. 4;

FIG. 6 is a pictorial view of the locking mechanism, shown removed from the telescopic tubes;

FIG. 7 is a fragmentary perspective view of the release mechanism removed from the telescopic tubes;

FIG. 8 is a cross-sectional view of the release mechanism shown mounted to the connecting head on the gas spring; and

FIG. 9 is a fragmentary perspective view of the release mechanism, taken from the side opposite that shown in FIG. 7.

### DETAILED DESCRIPTION OF THE PREFERRED EMBODIMENT

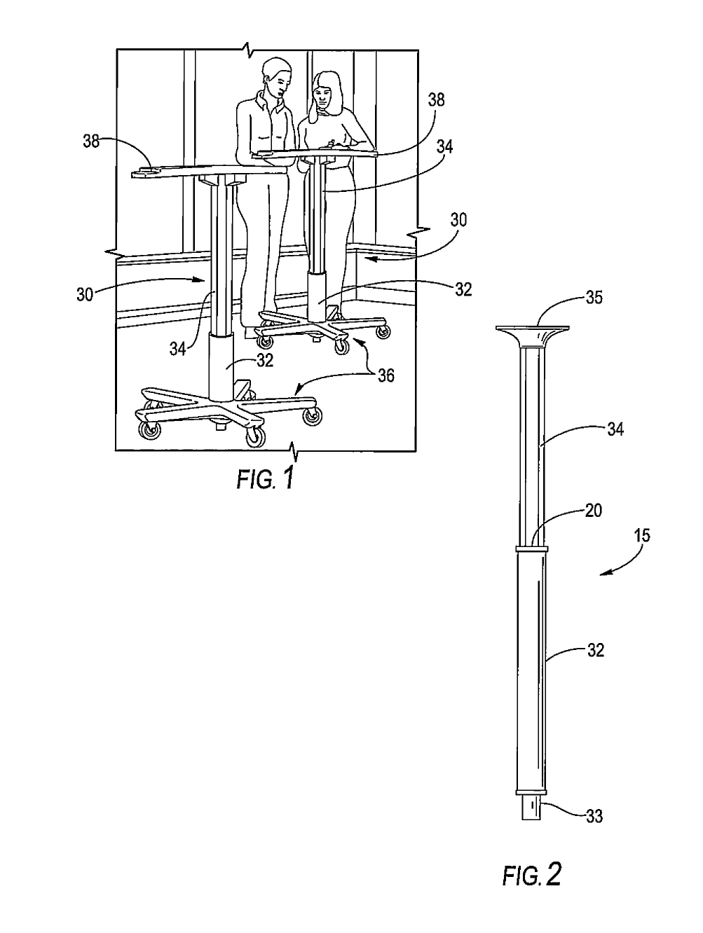

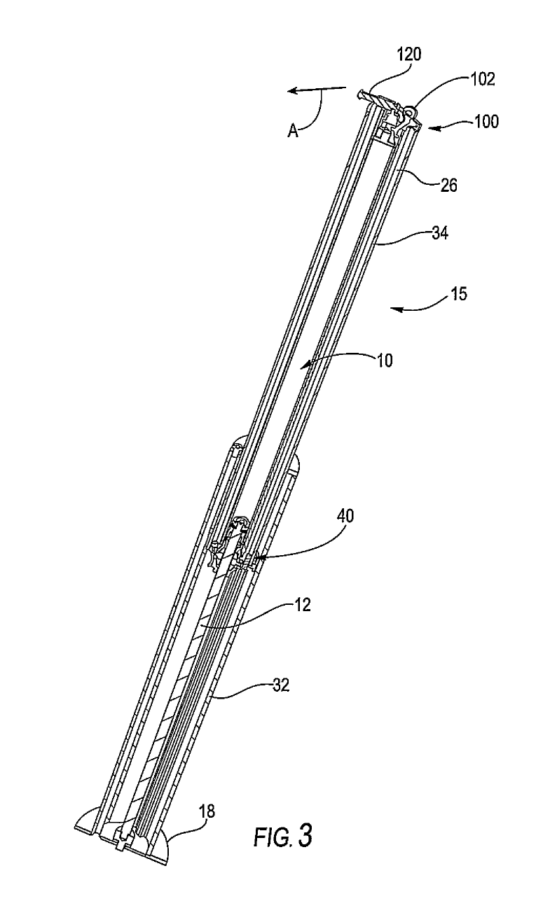

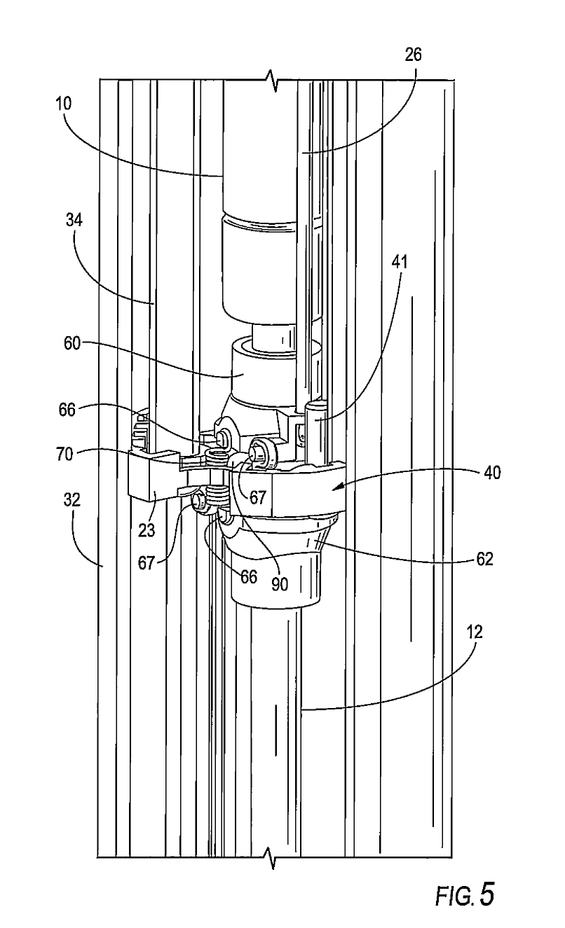

FIG. 1 shows adjustable tables 30 which include a height adjustment assembly 15 (FIG. 2) including telescopic tubes 32 and 34 extending between a floor support 36 and a table surface 38. FIG. 2 shows one of the table legs 15 with a support flange 35 at the upper end of telescopic tube 34 and a fitting 33 which extends into a socket in the floor support 36 of FIG. 1. The telescopic tube 34 slideably extends within outer tube 32 with polymeric bearings 20 (FIGS. 2) and 23 (FIG. 5) providing smoothly guided movement between the tubes 32, 34. These bearings and the general construction of the leg 15 are disclosed in U.S. patent application Ser. No. 61/758,997 filed on Jan. 31, 2013, entitled SELF-ALIGNING AXIAL BEARING, the disclosure of which is incorporated herein by reference. Within the telescopic tubes, there is a fluid spring, such as gas spring 10 shown in FIG. 3, with an extendable and retractable rod 12 to raise and lower the extruded inner table support tube 34. For such purpose, the opposite ends of gas spring 10 are conventionally coupled to each of the respective tubes 32, 34 so that extension of rod 12 causes the overall length of the tubes to extend. Fixedly coupled to the lower end of extruded tube 34 is the locking mechanism 40 incorporating the safety release 100 (FIGS. 3 and 7-9) of the present invention. The outer tube 32 is mounted to support member 33 (or 18 in FIG. 3), in turn, coupled to the floor support 36. The orientation of the telescopic tubes can be reversed depending upon a particular application.

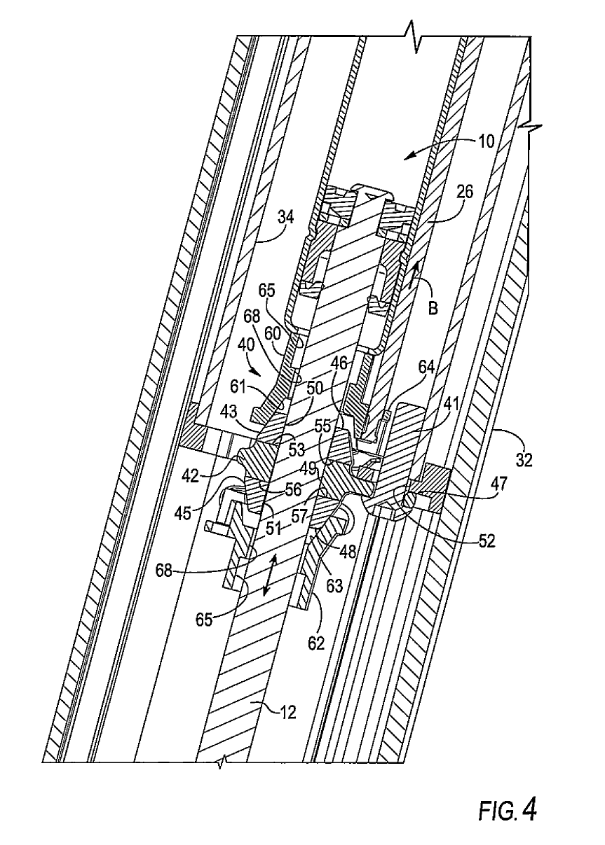

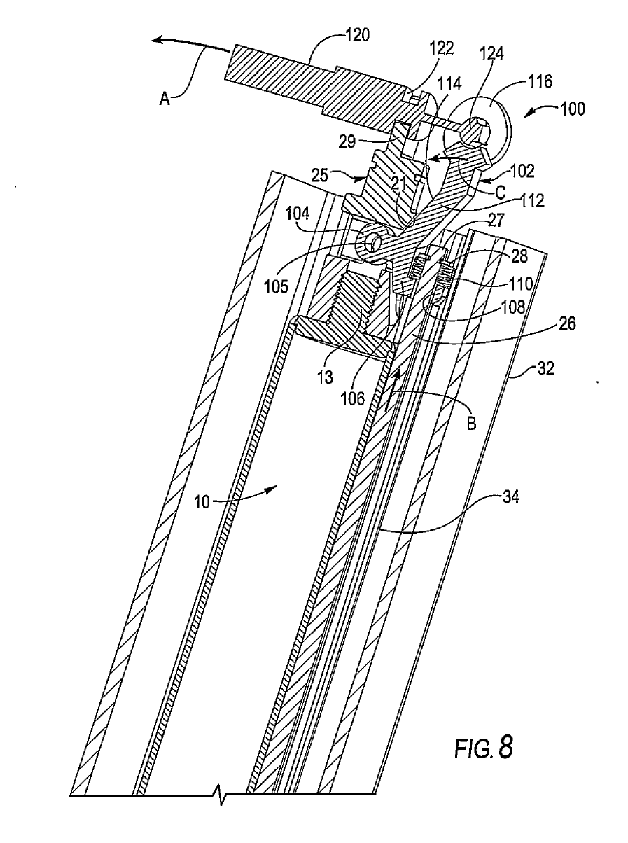

The leg assembly 15 so-formed also includes a safety release 100 which includes a cable release 120 (FIG. 3) which is coupled to a control handle (not shown) and is limited in its movement, as shown by arrow A, to a few millimeters as described below. A coupling 124, acting through leg 112, (FIG. 8) couples the cable release 120 to a release rod 26, which, when raised in the direction of arrow B in FIG. 8, releases the locking mechanism 40 as described below. The locking mechanism 40, which is secured to telescopic tube 34, grips the rod 12 extending from gas spring 10 in any desired position selected by the user by moving rod 26 upwardly, as indicated by arrow B in the figures, to release the grip on rod 12 by locking mechanism 40. The table surface can then be raised manually with gas assist or pushed down until the desired position of the table is reached. The operation of the locking mechanism is best seen in FIGS. 4-6.

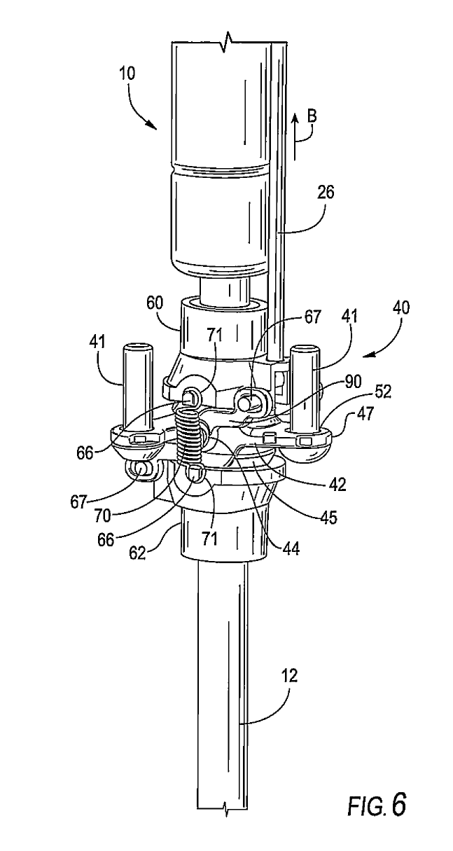

The locking mechanism 40 comprises a lock base 42, which is a generally triangular member having a central aperture 49 (FIG. 4) surrounding piston rod 12. It includes three lateral flanges 47 with apertures 52 through which three screws 41 extend to securely fix the lock base 42 and hence the locking mechanism 40 to threaded extrusions of the extruded hexagonal inner support tube 34 to secure the locking mechanism to the lower end of tube 34. The outer tube 32 is fixed and is attached to the table base, while the inner extruded tube 34 moves up and down with the rod 12 sliding through locking mechanism 40, when in a released position, to raise and lower the table surface 38 attached to the upper end of extruded tube 34. Associated with the lock base 42 are opposed upper and lower conical cam plates 46, 48 with external conical surfaces 43 and 45 (FIGS. 4 and 6). Surfaces 43, 45 are engaged by interior conical mating surfaces 61 and 63 of upper and lower movable clamping members 60 and 62 (FIGS. 4-6), respectively. The plates 46, 48 have central apertures 50, 51 (FIG. 4) which generally align with aperture 49 of lock base 42 and receive rod 12, which extends through members 60, 46, 42, 48 and 62, as best seen in FIG. 4. Lock base 42 has an upper surface 53 which is slideably engaged by the lower surface 55 (FIG. 4) of conical cam plate 46. Similarly, the lower surface 56 of lock base 42 is engaged by the upper surface 57 of conical cam plate 48. This sliding or floating arrangement of the cam plates 46, 48 allows the tapered clamping members 60, 62 to better engage the offset cam plates to effect locking of the locking member 40 to rod 12. The construction of the locking mechanism is described in greater detail in the copending patent application entitled DOUBLE ACTING FLUID CYLINDER LOCK, Serial No. (Atty. Docket No. SUS001 P345) filed on even date herewith, the disclosure of which is incorporated herein by reference.

Compression springs 70 (FIGS. 5 and 6) are mounted on both sides of the lock base 42 and urge members 60, 62 in a compressed position against lock base 42. Members 60, 62 have center apertures 65 (FIG. 4) which are offset a distance of about 1 mm from the axis of their conical surfaces 61, 63, as disclosed in greater detail in the above identified patent application entitled DOUBLE ACTING FLUID CYLINDER LOCK. This offset shifts and/or tilts members 60, 62 under the forces of springs 70 such that, when compressed to the opposed conical surfaces 43 and 45 of conical cam plates 46, 48, the inner cylindrical surfaces 68 (FIG. 4) of center apertures 65 bind to the outer surface of cylindrical rod 12, thereby locking the inner extruded tube 34 in a selected adjusted position. A plastic bearing sleeve 23, shown in FIG. 5, facilitates movement of tubes 32 and 34 when the locking mechanism is unlocked.

The unlocking of mechanism 40 is controlled by the rod 26 of safety release 100, which rod is coupled to the bracket 64 (FIG. 4) of upper clamping member 60, which has outwardly extending pins 67 on each side (FIG. 5). Pins 67 extend through apertures in the opposite ends of pivoted levers 90, which are pivotally mounted to lock base 42 by pivot axles 44 (FIG. 6) integrally extending from opposite sides of the lock base 42. Springs 70 have ends 71 which fit over tabs 66 in the identical clamping members 60, 62 as also illustrated in FIG. 6. Springs 70 hold the levers 90 in place on lack base 42, as best seen in FIG. 6.

When rod 26 is moved upwardly in the direction of arrow B in FIG. 6, levers 90 rotate in a counterclockwise direction, as viewed in FIG. 6, to raise clamping member 60 away from lock base 42 and associated cam plate 46, as well as pushing member 62 downwardly away from the lock base 42 and associated cam plate 48, thereby allowing the apertures 65 of clamping members to move to a coaxial position around rod 12. This releases the locking force of members 60, 62 against rod 12 and permits the table supporting extruded tube 34 to move up and down on rod 12 extending or collapsing the telescopic tubes 32, 34.

The weight on the table surface is transferred by lock base 42 and conical cam plates 46, 48 to one or the other of the clamping members 60, 62 of the locking mechanism. When the weight exceeds the force of gas spring 10, the lower clamping member 62 locks against the rod 12 as the conical surface 45 of cam plate 48 (FIG. 4) pushes against conical surface 63 of clamping member 62. Thus, the actual weight of the table on members 60, 62 offset by the force of gas spring 10 causes the apertures 65 of members 60, 62 offset from the central aperture 49 of locking base 42 to increase the effect of the locking action. When the weight on the table surface is less than the force of gas spring 10, lock base 42 raises and conical surface 43 of plate 46 engages the conical surface 61 of upper clamping member 60 to prevent the undesired raising of the table. Thus, the table surface will remain in a selected adjusted position until such time as the safety release 100 is actuated. The heavier the weight on the table, the more locking force is applied, with the springs 70 positioning locking members 60, 62 into a locking position. By providing members 60 and 62 on opposite sides of the locking base 42, the table is locked against either raising or lowering until the release rod 26 is moved upwardly in the direction of arrow B.

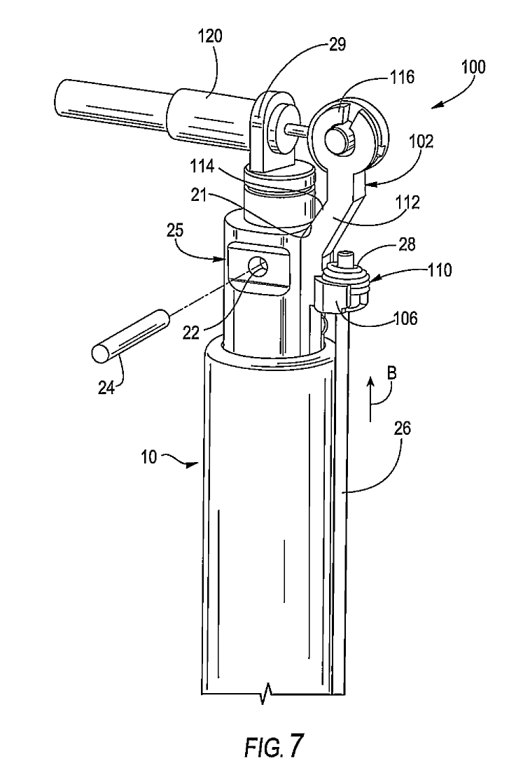

The locking mechanism 40 (FIG. 3) grips the rod 12 extending from gas spring 10 in any desired position selected by the user until it is desired to change the position of the table. In which case, cable release 120 (FIGS. 7-9) is drawn inwardly (to the left in FIGS. 3 and 7), moving rod 26 upwardly, to release the grip on rod 12 by locking mechanism 40. Unless overloaded or under loaded, the table can then be lowered or raised under the influence of gas spring 10. The safety release 100 prevents the release of the locking mechanism when the table is overloaded, such that it will not precipitously drop. If the weight on the table is significantly less than the force provided by the gas spring, the safety release will also prevent the release of the locking mechanism, such that the table surface will not quickly raise. The operation of the release assembly 100 to accomplish these features is best understood by reference to FIGS. 7-9.

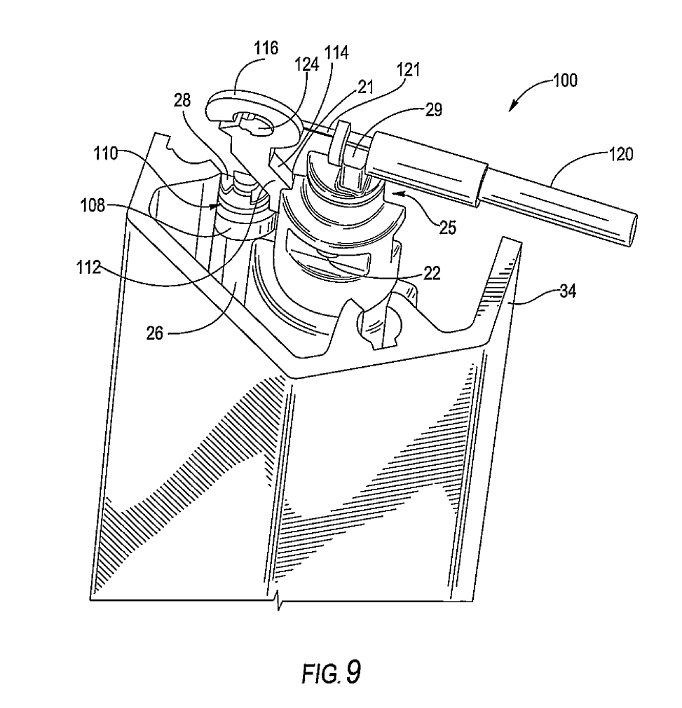

The safety release is pivotally secured to connecting head 25 of the gas spring 10. Connecting head 25 is threadably secured to a threaded rod 13 at the upper end of gas spring 10, as seen in FIG. 8, and comprises a generally cylindrical member having an aperture 22 therein for receiving a pivot pin 24 (FIG. 7), which pivotally mounts a pivot link 102 to the connecting head 25. Pivot link 102 includes a circular mount 104 (FIG. 8) having an aperture 105 therein for receiving pivot pin 24, allowing the pivot lever limited pivoting motion (less than about 10°) which is controlled by a beveled stop surface 21 on connecting head 25, as best seen in FIGS. 8 and 9. Pivot link 102 includes a lower cup-shaped leg 106 with a aperture 108 therein surrounding release control rod 26. The upper end 27 of rod 26 includes a snap ring 28. Between the snap ring 28 and the upper surface of leg 106 are a plurality of Belleville washers 110 with, in the preferred embodiment, between about three to about seven Belleville washers typically employed. In some applications, a slightly greater number may be employed. The washers 110 serve as a compression spring in the manner described below. Pivot link 102 also includes an upwardly extending angled leg 112 with a section 114 which engages inclined stop surface 21 of connecting head 25, thereby limiting the counterclockwise rotation in a direction indicated by arrow C in FIG. 8 of the lever arm and, therefore, the movement of leg 106 upwardly against Belleville washers 110.

Leg 112 extends to an upwardly extending section 114 and then to a circular mount 116 for the pivot link 102. The connecting head includes a socket 29 for receiving cable release 120, which has a collar with a mating recess 122 that fits within socket 29 while holding cable release 120 in position on the connecting head 25. An end of cable release 120 includes a coupling element 124, which extends within mount 116 in a pivotal fashion, such that actuating of cable release 120 will draw the cable 121 of cable release 120 in the direction indicated by arrow A in FIG. 8 and will rotate pivot link 102 in the direction indicated by arrow C. Cable release 120 is conventionally coupled to a handle (not shown), which is easily accessible to the user of the table or other device using the telescopic tubes for adjusting the height thereof. In some orientations, the cable release 120 can be oriented in reverse, such that it becomes a foot pedal if the telescopic tubes are reversed.

Normally, upon actuating cable release 120, the washers 110 will not significantly compress and will allow the movement of rod 26 upwardly, as indicated by arrow B. If there is an excessive weight on the table or no weight, the locking member 40 will increase the locking force on rod 12, which, in turn, requires a greater force on rod 26 to release the clamping members 60 and 62. This compresses washers 110 in a lost motion fashion and rod 26 will not be moved. If, for example, a 200 pound weight is placed on the table, it is desired to prevent the table from slamming down when someone attempts to adjust the table height. Similarly, if there is no load on the table, again the locking mechanism 40 will require a greater release force on rod 26 than the compression force on springs 110. In either situation, the release rod 26 will require a significant force to release the locking mechanism 40. In such case, pressing down on cable release 120 will rotate pivot link 102 in a counterclockwise direction. The Belleville washers 110 will compress against snap clip 28 at the upper end 27 of rod 26 due to the excessive force required to move rod 26. This prevents the movement of rod 26 until the stop limit of pivot link 102 is reached, when surface 114 engages stop 21, and release rod 26 will not move. Thus, the compressible Belleville washers 110 provide a safety factor preventing the release of the locking mechanism in the event a very heavy object is on the table surface. When a normal load is on the table, actuating cable release 120 will raise rod 26 to release the locking member 40.

Other forms of compression springs with limited movement could also be employed in place of the Belleville washer. Also, other forms of actuators can be employed in place of the pivot link 102. Such actuators may include linear actuators that are constrained in their movement and employ spring(s) to provide the same safety release function as provided by the embodiment described in detail herein.

These and other modifications will become apparent to those skilled in the art without departing from the spirit or scope of the invention as defined by the appended claims.

The invention claimed is:

1. A safety release for a clamping brake mechanism in which the clamping force increases with increasing loads and the force required to release the clamping brake also increases, said safety release comprising:
a fixed housing;
an actuator coupled to said housing and constrained to move through a predetermined distance;
a release rod coupled to an end of said actuator; and
a compression spring extending between said end of said actuator and said release rod such that said spring will compress in the event the force to move the release rod exceeds the spring constant, thereby compressing the spring and preventing the release rod from moving to release the clamping brake.

2. The safety release as defined in claim 1 wherein said compression spring comprises at least one Belleville washer.

3. The safety release as defined in claim 2 wherein said compression spring comprises a plurality of stacked Belleville washers.

4. The safety release as defined in claim 1 wherein said compression spring comprises of from about three to about seven stacked Belleville washers.

5. The safety release as defined in claim 1 wherein said actuator engages said compression spring on one side and said compression spring engages a stop on said release rod opposite said one side.

6. The safety release as defined in claim 5 wherein said pivot link moves in a predetermined arc of from about 5° to about 10°.

7. The safety release as defined in claim 6 wherein said stop comprises an annular recess near said end of said release rod and a snap ring fitted in said annular recess.

8. The safety release as defined in claim 1 wherein said compression spring compresses an amount of about 5 mm.

9. A safety release for a clamping brake mechanism used with the rod of gas spring adjustable telescopic tubes, said safety release comprising:
a gas spring including a connecting head;
a release coupled to said connecting head;
a pivot link coupled to said cable release and engageable with said connecting head to be constrained to pivot through a predetermined arc;
a release rod coupled to an end of said pivot link remote from said cable release; and
a compression spring extending between said end of said pivot link and said release rod such that said spring will compress in the event the force to move the release rod exceeds the spring constant, thereby compressing the spring and through the predetermined arc of movement of said pivot link, preventing the release rod from moving to release the clamping brake.

10. The safety release as defined in claim 9 wherein said compression spring comprises a plurality of stacked Belleville washers.

11. The safety release as defined in claim 9 wherein said compression spring comprises of from about three to about seven stacked Belleville washers.

12. The safety release as defined in claim 9 wherein said pivot link engages said compression spring on one side and said compression spring engages a stop on said release rod opposite said one side.

13. The safety release as defined in claim 12 wherein said stop comprises an annular recess near said end of said release rod and a snap ring fitted in said annular recess.

14. The safety release as defined in claim 9 wherein said predetermined arc is from about 5° to about 10°.

15. The safety release as defined in claim 9 wherein said compression spring compresses an amount of about 5 mm.

16. A brake and safety release mechanism for a rod comprising:
a housing;
a lock base coupled to said housing and having an axially extending central aperture and an associated pair of opposed conical surfaces surrounding said aperture;
a pair of clamping members positioned on opposite sides of said lock base, each of said members including a center aperture and a conical surface having an axis offset from the axis of said center aperture;
a coupling for moving said clamping members into engagement with said lock base with the respective conical surfaces in contact such that said center apertures of said clamping members are offset from said central aperture of said lock base;
a cable release coupled to said housing;
a pivot link coupling an end of said cable release and constrained to pivot through a predetermined arc;
a release rod coupled to an end of said pivot link remote from said cable release and to said coupling; and
a compression spring extending between said end of said pivot link and said release rod such that said spring will compress in the event the force to move the release rod exceeds the spring constant, thereby compressing the spring and preventing the release rod from moving to release the clamping brake.

17. The brake and safety release mechanism as defined in claim 16 wherein said actuator includes a pivot pin extending from said lock base and a pivot lever pivotally coupled to said pivot pin and having opposite ends coupled to said clamping members such that as said pivot lever is rotated said clamping members move toward or away from said lock base.

18. The brake and safety release mechanism as defined in claim 17 and further including a bias spring coupled between said clamping members to urge them into contact with said conical surfaces associated with said lock base.

19. The brake and safety release mechanism as defined in claim 18 and further including a release rod coupled to one of said clamping members for moving said clamping members away from each other.

20. The brake and safety release mechanism as defined in claim 19 wherein said lock base includes a pair of opposed pivot pins and said coupling includes a pair of pivot levers coupled to said pivot pins of said lock base and to said clamping members.

21. The brake and safety release mechanism as defined in claim 15 wherein said compression spring includes at least one Belleville washer.
